(19) United States
(12) Patent Application Publication
(10) Pub. No.: US 2015/0296079 A1
(43) Pub. Date: Oct. 15, 2015

(54) GATEWAY AND METHOD FOR DELAYING TELEPHONE RINGING

(71) Applicants: AMBIT MICROSYSTEMS (SHANGHAI) LTD., Shanghai (CN); HON HAI PRECISION INDUSTRY CO., LTD., New Taipei (TW)

(72) Inventor: JUN SONG, Shanghai (CN)

(21) Appl. No.: 14/476,463

(22) Filed: Sep. 3, 2014

(30) Foreign Application Priority Data
Apr. 14, 2014 (CN) 2014101483659

(51) Int. Cl. H04M 3/436; H04M 7/12; H04M 7/00; H04M 3/42

(52) U.S. Cl. CPC H04M 3/436; H04M 3/42059; H04M 7/125; H04M 7/0033; H04W 88/16

(57) ABSTRACT

A gateway in network telephone system screens VoIP and PSTN calls received and activates or does not activate an audible ringing of a local telephone device according to certain conditions, to prevent telephone harassment. The gateway includes modules, to establish a familiar number table, to detect whether a call has a caller ID, whether the caller ID is stored in the familiar number table, and whether the call duration exceeds certain time periods.

### FIELD

The disclosure generally relates to communications.

### BACKGROUND

Due to the rapid development of current social network communications, networking and telephone communications have become an essential tool. However, in some cases, or at certain times, people often receive calls from unknown sources, and the ringing phone impacts people's lives and work. In order to prevent harassment by telephone, anti-harassment methods can employ management techniques such as blacklisting, and generally delay or refuse to answer a ringing telephone.

### BRIEF DESCRIPTION OF THE DRAWINGS

Many aspects of a network equipment and method for selecting communication path can be better understood with reference to the following drawings. The components in the drawings are not necessarily drawn to scale, the emphasis instead being placed upon clearly illustrating the principles of the network equipment and the method for selecting communication path. Moreover, in the drawings, like reference numerals designate corresponding parts throughout the several views. Wherever possible, the same reference numbers are used throughout the drawings to refer to the same or like elements of an embodiment.

In the present specification and claims, the word “a” or “an” preceding an element does not exclude the presence of a plurality of such elements. Further, the word “comprising” does not exclude the presence of elements or steps other than those listed.

FIG. 1 is a diagrammatic view of the function modules of one embodiment of a communications gateway.

FIG. 2 is a flowchart illustrating one embodiment of a method for delaying the ringing of a VOIP telephone.

FIG. 3 is a flowchart illustrating one embodiment of a method for delaying the ringing of a PSTN telephone.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

The word “module” as used hereinafter, refers to logic embodied in hardware or firmware, or to a collection of software instructions, written in a programming language, such as, for example, JAVA, C, or assembly. One or more software instructions in the modules may be embedded in firmware such as in an EPROM. It will be appreciated that modules can comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

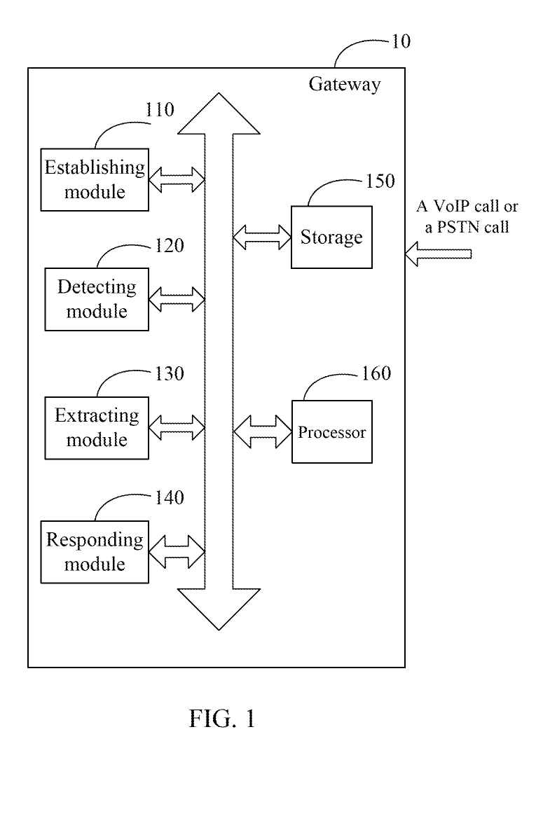

FIG. 1 shows one embodiment of function modules of a gateway 10. In one embodiment, the gateway 10 includes an establishing module 110, a detecting module 120, an extracting module 130, a responding module 140, a storage system 150, and a processor 160. These modules comprise software programs which are stored in the storage system 150. The processor 160 runs the software programs to achieve functions of these modules. In one embodiment, the gateway 10 handles both Voice over Internet Protocol (VOIP) calls and Public Switched Telephone Network (PSTN) calls.

In one embodiment, the storage system 150 of the gateway 10 records the number of times a call is made from a certain number, the times of day that such calls are made, and the times and frequency of certain callers at any time to review call habits of the users. The establishing module 110 establishes a familiar number table to store telephone numbers according to call habits. The familiar number table can include a name, number(s), number of times a call has been made, and the times of the day when a call has been made.

When the gateway 10 receives a VoIP call from a network telephone device, the detecting module 120 detects whether or not the incoming VoIP call contains a telephone number of the VoIP caller. If the incoming VoIP call contains a telephone number of the VoIP caller, the extracting module 130 extracts the telephone number of the VoIP call. If the incoming VoIP call does not contain the telephone number of the VoIP caller, then the extracting module 130 waits. If the VoIP incoming caller lasts not longer than a preset time (for example, 2 seconds), that is to say that the VoIP incoming caller breaks the connection before the end of the preset time of 2 seconds, the responding module 140 keeps the telephone device silent. If the VoIP incoming call maintains the connection for the preset time (for example, 2 seconds) or longer, the responding module 140 can activate the audible ringing of the telephone device.

Once the extracting module 130 has extracted the telephone number of the VoIP call, the detecting module 120 detects whether or not the telephone number of the VoIP call is contained in the familiar number table. If the telephone number of the VoIP call is contained in the familiar number table, the responding module 140 can activate the audible ringing of the telephone device. If the telephone number of the VoIP call is not contained in the familiar number table, the responding module 140 continues to wait.

Once the telephone device is activated to audibly ring, and the VoIP incoming caller is answered, the VoIP call talking time is recorded. The detecting module 120 detects whether the VoIP caller talks for a time which exceeds a preset value (60 seconds). If the VoIP caller talks for a time which exceeds a preset value (60 seconds), the establishing module 110 establishes the calling number in the familiar number table. If the VoIP caller breaks the connection within a preset duration (60 seconds), the gateway 10 ignores the number of the VoIP caller.

In summary, when the gateway receives the VoIP calls, the modules of the gateway 10 detect the caller ID and whether or not the caller ID is stored in the familiar number table. Known or established calling numbers are extracted and determined, and managed on the basis of preset time durations, and the ringing of the telephone device is controlled to delay, to prevent telephone harassment.

When the gateway 10 receives a PSTN call, the method of delaying an audible ringing is similar to that of the VoIP call. Thus the method of delaying the audible ringing in the case of PSTN calls is omitted for simplicity.

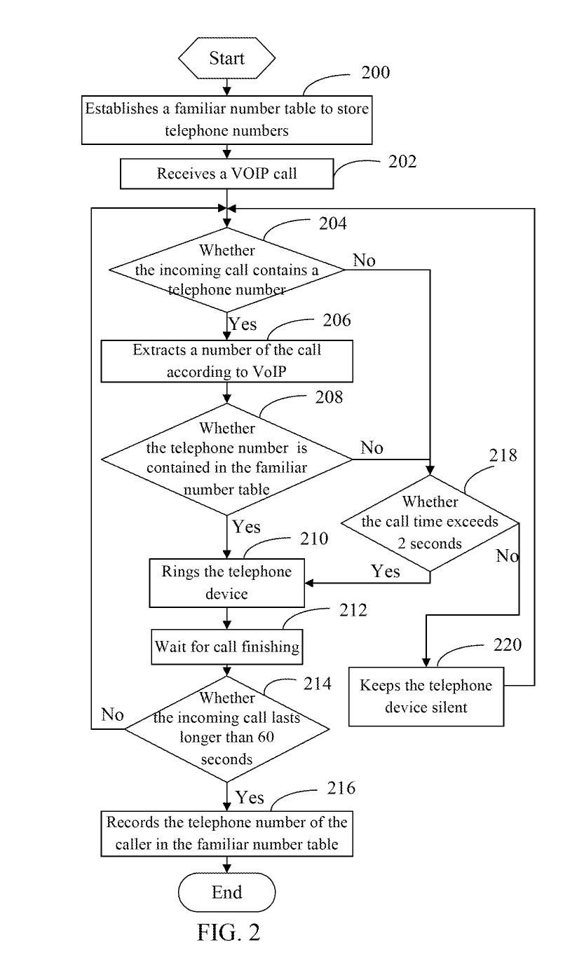

FIG. 2 is a flowchart illustrating one embodiment of a method for delaying the audible ringing of a VOIP telephone. The method is applied in the gateway 10, and achieved by the modules of the FIG. 1.

In step 200, the establishing module 110 establishes a familiar number table to store telephone numbers.

In step 202, gateway 10 receives a VoIP call.

In step 204, the detecting module 120 determines whether or not the incoming call contains a telephone number of the caller; if the incoming call contains a telephone number of the caller, the method then proceeds to step 206. If the incoming call does not contain a telephone number of the caller, the method then proceeds to step 218.

In step 206, the extracting module 130 extracts the telephone number of the VoIP caller.

In step 208, the detecting module 120 detects whether or not the telephone number of the caller is contained in the familiar number table; if the telephone number of the caller is contained in the familiar number table, the method then proceeds to step 210. If the telephone number of the caller is not contained in the familiar number table, the method then proceeds to step 218.

In step 210, the responding module 140 causes the telephone device to audibly ring.

In step 212, a VoIP call is answered.

In step 214, the detecting module 120 detects if the connection made with the incoming call lasts longer than 60 seconds. If the incoming call lasts longer than 60 seconds, the method then proceeds to step 216, but if the VoIP caller breaks the connection within a time period of 60 seconds, the method then proceeds to step 204.

In step 216, the establishing module 110 records the telephone number of the caller in the familiar number table.

In step 218, the detecting module 120 detects whether the VoIP call is maintained by the VoIP caller for a period of time exceeding 2 seconds. If the VoIP call time exceeds 2 seconds, the method then proceeds to step 210, but if the VoIP call time does not exceed 2 seconds, the method then proceeds to step 220.

In step 220, the responding module 140 ignores the VoIP call and does not activate an audible ringing of the telephone device.

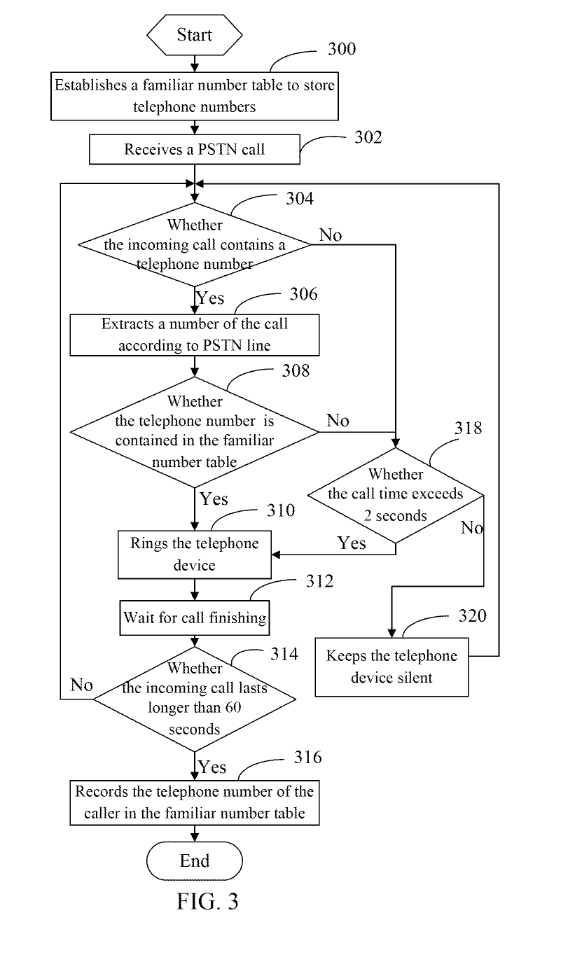

FIG. 3 is flowchart illustrating one embodiment of a method for delaying an audible ringing of a PSTN telephone. The method is applied by the gateway 10, and achieved by the modules of FIG. 1.

In step 300, the establishing module 110 establishes a familiar number table to store telephone numbers.

In step 302, gateway 10 receives a PSTN call.

In step 304, the detecting module 120 determines if the incoming call contains a telephone number of the caller. If the incoming PSTN call contains a telephone number the method then proceeds to step 306; if the incoming call does not contain a telephone number of the caller, the method then proceeds to step 318.

In step 306, the extracting module 130 extracts the number of the caller from the PSTN connection.

In step 308, the detecting module 120 detects whether or not the telephone number of the caller is contained in the familiar number table, and if the telephone number of the caller is contained in the familiar number table, the method then proceeds to step 310. If the telephone number of the caller is not contained in the familiar number table, the method then proceeds to step 318.

In step 310, the responding module 140 causes the telephone device to audibly ring.

In step 312, the PSTN call is answered.

In step 314, the detecting module 120 detects whether the connection created for the incoming PSTN call is maintained by the PSTN caller for longer than 60 seconds. If the incoming call lasts longer than 60 seconds, the method then proceeds to step 316, but if the incoming call does not last longer than 60 seconds, the method then proceeds to step 304.

In step 316, the establishing module 110 records the telephone number of the caller in the familiar number table.

In step 318, the detecting module 120 detects whether the PSTN call is maintained by the PSTN caller for 2 seconds or more. If the PSTN call is maintained for 2 seconds or more, the method then proceeds to step 310. If the PSTN caller breaks the connection before the end of the 2 seconds period, the method then proceeds to step 320.

In step 320, the responding module 140 ignores the PSTN call and does not activate the audible ringing of the telephone device.

In summary, when the gateway receives VoIP calls or PSTN calls, the modules of the gateway 10 detect the caller ID and whether or not the caller ID is stored in the familiar number table then applies preset periods of time to the calls, and controls the audible ringing of the telephone device to prevent telephone harassment.

It is to be understood, however, that even though numerous characteristics and advantages of the exemplary disclosure have been set fourth in the foregoing description, together with details of the structure and function of the exemplary disclosure, the disclosure is illustrative only, and changes may be made in detail, especially in matters of shape, size, and arrangement of parts within the principles of this exemplary disclosure to the full extent indicated by the broad general meaning of the terms in which the appended claims are expressed.

What is claimed is:

1. A gateway configured to process network calls for a telephone device, comprising:
a processor; and
a storage system, storing one or more software programs in the form of computerized codes operable to be executed by the processor, the one or more software programs comprising instructions for:
establishing a number table to store telephone numbers;
detecting an incoming call to the telephone device;
determining whether or not incoming call data contains a telephone number of the caller and whether or not the incoming call lasts longer than a preset time period;
in response to the incoming call containing a telephone number of the caller, extracting the telephone number of the caller;
determining whether or not the telephone number of the caller is contained in the number table; and
in response to the incoming call lasting shorter than the preset time period and the telephone number of the caller being contained in the number table, preventing a ringtone from being executed.

2. The gateway of claim 1, wherein the one or more software programs further comprises instructions for:
in response to talking time of the incoming call exceeds a preset time, recording the telephone number of the caller in the familiar number table.

3. The gateway of claim 1, wherein the one or more software programs further comprises instructions for:
in response to the incoming call not containing the telephone number of the caller and the incoming call lasts shorter than the preset time period, keeping the telephone device silent.

4. The gateway of claim 1, wherein the one or more software programs further comprises instructions for:
in response to the incoming call not containing the telephone number of the caller and the incoming call lasting longer than the preset time period, ringing the telephone device.

5. The gateway of claim 1, wherein the one or more software programs further comprises instructions for:
in response to the telephone number of the caller not contained in the familiar number table and the incoming call lasting longer than the preset time period, ringing the telephone device.

6. The gateway of claim 1, wherein the one or more software programs further comprises instructions for:
in response to the telephone number of the caller contained in the familiar number table, ringing the telephone device.

7. The gateway of claim 1, wherein the incoming call is from Voice over Internet Protocol network or from Public Switched Telephone Network.

8. A method for a gateway delaying to ring a telephone device comprising:
establishing a familiar number table to store telephone numbers;
detecting an incoming call from a caller to the telephone device;
determining whether or not the incoming call contains a telephone number of the caller and whether or not the incoming call lasts longer than a preset time period;
in response to the incoming call containing a telephone number of the caller, extracting the telephone number of the caller;
determining whether or not the telephone number of the caller is contained in the familiar number table; and
in response to the incoming call lasting shorter than the preset time period and the telephone number of the caller being contained in the familiar number table, keeping the telephone device silent.

9. The method for a gateway delaying to ring of claim 8, further comprising:
in response to talking time of the incoming call exceeds a preset time, recording the telephone number of the caller in the familiar number table.

10. The method for a gateway delaying to ring of claim 8, further comprising:
in response to the incoming call not containing the telephone number of the caller and the incoming call lasts shorter than the preset time period, keeping the telephone device silent.

11. The method for a gateway delaying to ring of claim 8, further comprising:
in response to the incoming call not containing the telephone number of the caller and the incoming call lasting longer than the preset time period, ringing the telephone device.

12. The method for a gateway delaying to ring of claim 8, further comprising:
in response to the telephone number of the caller not contained in the familiar number table and the incoming call lasting longer than the preset time period, ringing the telephone device.

13. The method for a gateway delaying to ring of claim 8, further comprising:
in response to the telephone number of the caller contained in the familiar number table, ringing the telephone device.

14. The method for a gateway delaying to ring of claim 8, wherein the incoming call is from Voice over Internet Protocol network or from Public Switched Telephone Network.
